(19) United States
(12) Patent Application Publication
(10) Pub. No.: US 2026/0088515 A1
(43) Pub. Date: Mar. 26, 2026

(54) PHASED-ARRAY APPARATUS AND PHASED-ARRAY SYSTEM

(71) Applicant: HUAWEI TECHNOLOGIES CO., LTD., Shenzhen (CN)

(72) Inventors: Yongfu Tang, Chengdu (CN); Guolong Huang, Chengdu (CN); Liang Hu, Chengdu (CN)

(21) Appl. No.: 19/409,962

(22) Filed: Dec. 5, 2025

Related U.S. Application Data
(63) Continuation of application No. PCT/CN2023/099206, filed on Jun. 8, 2023.

(51) Int. Cl. H01Q 21/00; H01Q 1/02

(52) U.S. Cl. CPC H01Q 21/0006; H01Q 1/02

(57) ABSTRACT

A phased-array apparatus includes a first chip configured to one or more of send or receive a first signal. The phased-array apparatus also includes a first functional layer on a first surface of the first chip. The first chip is connected to an antenna element by way of a redistribution wiring on the first functional layer. The redistribution wiring extends along the first surface of the first chip. A normal direction of a first plane on which the first surface of the first chip is located is perpendicular to a normal direction of a second plane on which a surface of the antenna element is located.

### CROSS-REFERENCE TO RELATED APPLICATIONS

This application is a continuation of International Application No. PCT/CN2023/099206, filed on Jun. 8, 2023, the disclosure of which is hereby incorporated by reference in its entirety.

### TECHNICAL FIELD

Embodiments of this application relate to the field of communication technologies, and more specifically, to a phased-array apparatus and a phased-array system.

### BACKGROUND

In research and design of high-frequency and high-density phased-array front-end integration, high-density interconnection integration, low-loss signal transmission, and highly efficient heat dissipation design are important technical challenges faced by researchers. Especially, as a system operating frequency band gradually increases, a size of an antenna array surface is reduced proportionally with an operating wavelength. However, a size of a radio frequency chip in a radio frequency front-end microsystem, such as a power amplifier (PA), a low-noise amplifier (LNA), a filter, or a switch, is not reduced proportionally with reduction of the operating wavelength, leading to a mismatch between a planar size of a high-frequency phased-array front-end chip and the size of the antenna array surface. Further, a mismatch between a planar size of the radio frequency front-end microsystem and the size of the antenna array surface causes a relatively long transmission link from a chip having a receiving and/or sending function to an edge element of the array surface, and further causes a relatively large transmission loss of a radio frequency signal.

Therefore, how to reduce the transmission loss of the radio frequency signal is a problem that requires further research.

### SUMMARY

Embodiments of this application provide a phased-array apparatus and a phased-array system, to reduce a signal transmission loss.

According to a first aspect, a phased-array apparatus is provided. The phased-array apparatus is connected to an antenna element. The phased-array apparatus includes: a first chip, where the first chip is configured to send and/or receive a first signal; and a first functional layer, where a redistribution wiring is disposed on the first functional layer, and the redistribution wiring is configured to connect the first chip and the antenna element, where the first functional layer is disposed on a first surface of the first chip, the redistribution wiring is disposed along the first surface of the first chip, and a normal direction of a plane on which the first surface of the first chip is located is perpendicular to a normal direction of a plane on which a surface of the antenna element is located.

In this manner, a chip is disposed in a direction perpendicular to the surface of the antenna element, and a wiring on a surface of the chip connects the chip and the antenna element, thereby greatly shortening a length of the wiring, shortening a transmission path of a chip signal, and reducing a signal transmission loss.

In some implementations, a transmission direction of the first signal is parallel to the normal direction of the plane on which the surface of the antenna element is located.

In some implementations, the phased-array apparatus further includes a first functional module, the first functional module is configured to electrically connect to the first chip, the first functional module is disposed on a first surface of the phased-array apparatus, and a normal direction of the first surface of the phased-array apparatus is perpendicular to a normal direction of the first surface of the first chip.

In some implementations, the first functional module includes at least one solder ball.

It should be understood that the first functional module is not limited to a solder ball. For example, the first functional module may alternatively be in another ball-less electrical connection form. For example, the first functional module may alternatively be a transition structure, and the transition structure may implement transition from a stripline to a microstrip and then to a waveguide, to implement an electrical connection. Alternatively, the first functional module includes at least one of a stripline, a microstrip, or a waveguide.

In some implementations, the phased-array apparatus further includes a second functional layer, the second functional layer is disposed on a second surface of the first chip, the normal direction of the first surface of the first chip coincides with a normal direction of the second surface of the first chip, and a distance exists between the first surface of the first chip and the second surface of the first chip.

In other words, if the surface of the chip on which the wiring is located is defined as a front side, a position at which the second functional layer is located is a back side of the chip.

In some implementations, the second functional layer is configured to dissipate heat.

In this manner, the heat dissipation functional layer is disposed along a long-side surface of the chip, so that heat dissipation efficiency can be improved.

In some implementations, a material of the second functional layer is metal.

In some implementations, a material of the second functional layer is copper.

It should be understood that the material of the second functional layer is not limited to a copper block. The second functional layer may be dense metal vias or a material with high thermal conductivity and compatible with an integration process.

In some implementations, the redistribution wiring is further configured to connect the first chip and a primary link.

In other words, the first chip is connected to both the antenna element and the primary link.

According to a second aspect, a phased-array apparatus is provided. The phased-array apparatus is connected to an antenna element. The phased-array apparatus includes: a second chip, where the second chip is configured to send and/or receive a second signal; a third chip, where the third chip is configured to send and/or receive a third signal; and a third functional layer, where a redistribution wiring is disposed on the third functional layer, and the redistribution wiring is configured to connect the second chip, the third chip, and the antenna element, where the third functional layer is disposed on a first surface of the second chip and a first surface of the third chip, a normal direction of a plane on which the first surface of the second chip is located is perpendicular to a normal direction of a plane on which a surface of the antenna element is located, a normal direction of a plane on which the first surface of the third chip is located is perpendicular to the normal direction of the plane on which the surface of the antenna element is located, the redistribution wiring is disposed along the first surface of the second chip, and the redistribution wiring is disposed along the first surface of the third chip.

It should be understood that the second chip and the third chip may be chips with a same function, or may be chips with different functions.

It should be further understood that the third functional layer may be a complete functional layer, and the second chip and the third chip share the functional layer. The third functional layer may also include different parts, where one part corresponds to the second chip, and the other part corresponds to the third chip.

In the phased-array apparatus, multiple chips are disposed in a direction perpendicular to the surface of the antenna element, and the multiple chips may share a same (wiring) functional layer, so that ultra-short path interconnection and low-loss transmission of a signal are implemented in a direction parallel to the surface of the chip, for example, signal transmission paths of the second chip and the third chip are shortened. Moreover, because the multiple chips share the same (wiring) functional layer, integration complexity can be reduced. In addition, when functions of the multiple chips are not completely the same, the phased-array apparatus has more complete functions, and can meet diversified service requirements.

In some implementations, a transmission direction of the second signal is parallel to the normal direction of the plane on which the surface of the antenna element is located, and a transmission direction of the third signal is parallel to the normal direction of the plane on which the surface of the antenna element is located.

In some implementations, the second chip and the third chip are at a same position in a normal direction of the first surface of the second chip, and the second chip and the third chip are at different positions in a direction parallel to the first surface of the second chip.

In other words, the second chip and the third chip are at different positions in a direction perpendicular to the antenna element, and are at a same position in a direction parallel to the surface of the antenna element. In other words, the second chip and the third chip are integrated in a direction perpendicular to the antenna element.

In some implementations, the phased-array apparatus further includes a fourth functional layer, the fourth functional layer is disposed on a second surface of the second chip and a second surface of the third chip, the normal direction of the first surface of the second chip coincides with a normal direction of the second surface of the second chip, a normal direction of the first surface of the third chip coincides with a normal direction of the second surface of the third chip, a distance exists between the first surface of the second chip and the second surface of the second chip, and a distance exists between the first surface of the third chip and the second surface of the third chip.

In some implementations, the fourth functional layer is configured to dissipate heat.

A heat dissipation layer integrated in a vertical direction is embedded on a back side of each chip package module in vertical multiple layers of chips, so that highly efficient heat dissipation can be implemented for the vertical multiple layers of chips.

In some implementations, a material of the fourth functional layer is metal.

In some implementations, a material of the fourth functional layer is copper.

It should be understood that the material of the second functional layer is not limited to a copper block. The fourth functional layer may be dense metal vias or a material with high thermal conductivity and compatible with an integration process.

In some implementations, the phased-array apparatus further includes a second functional module, the second functional module is configured to electrically connect to the second chip, the second functional module is disposed on a first surface of the phased-array apparatus, and a normal direction of the first surface of the phased-array apparatus is perpendicular to the normal direction of the first surface of the second chip.

In some implementations, the second functional module includes at least one solder ball.

For the second functional module, refer to the description of the first functional module in the first aspect. Details are not described again.

In some implementations, the redistribution wiring is further configured to connect the third chip and a primary link.

According to a third aspect, a phased-array system is provided. The phased-array system includes at least one phased-array apparatus according to the first aspect, or any possible implementation of the first aspect, or all the possible implementations of the first aspect, and/or at least one phased-array apparatus according to the second aspect, or any possible implementation of the second aspect, or all the possible implementations of the second aspect.

In other words, the phased-array system may include at least one phased-array apparatus integrated with a single chip, or may include at least one phased-array apparatus integrated with multiple chips, or may include both a phased-array apparatus integrated with a single chip and a phased-array apparatus integrated with multiple chips.

In this solution, chips are densely integrated, with their surfaces perpendicular to an antenna array surface, and a chip needs to implement signal (for example, a microwave signal, a power supply signal, or a control signal) transmission with a previous-stage link or a next-stage link only in a direction parallel to a surface of the chip, thereby effectively implementing low-loss transmission of a signal (for example, a high-frequency millimeter-wave signal). In addition, a size of the phased-array system matches that of the antenna array surface, and the array surface has a stronger expansion capability, so that a higher EIRP can be obtained in a same array surface area or on a same antenna scale, thereby effectively improving a communication/sensing capability of the high-frequency phased-array system.

In some implementations, a phase-center spacing between adjacent antenna elements is less than or equal to λ/2, where λ is a wavelength corresponding to an operating frequency of the antenna element.

According to a fourth aspect, an apparatus is provided. The apparatus includes a radio frequency unit, and the radio frequency unit includes the phased-array system according to the third aspect, or any possible implementation of the third aspect or all the possible implementations of the third aspect.

### BRIEF DESCRIPTION OF DRAWINGS

FIG. 1(a) to FIG. 1(c) are diagrams of structures of three high-density interconnection integration designs, in accordance with one or more embodiments.

FIG. 2 is a diagram of a sparse array layout on an antenna array surface, in accordance with one or more embodiments.

FIG. 3 is a diagram of a chip integrated package structure, in accordance with one or more embodiments.

FIG. 4 is a diagram of a structure of a phased-array apparatus, in accordance with one or more embodiments.

FIG. 5(a) is a diagram illustrating positions of a phased-array apparatus and an antenna element, in accordance with one or more embodiments.

FIG. 5(b) is a diagram illustrating surfaces of a chip, in accordance with one or more embodiments.

FIG. 5(c) is another diagram illustrating positions of a phased-array apparatus and an antenna element, in accordance with one or more embodiments.

FIG. 5(d) is a diagram illustrating a transmission direction of a signal, in accordance with one or more embodiments.

FIG. 6 is a diagram of a structure of another phased-array apparatus, in accordance with one or more embodiments.

FIG. 7(a) is a diagram illustrating surfaces of a phased-array apparatus, in accordance with one or more embodiments.

FIG. 7(b) is a diagram of another phased-array apparatus, in accordance with one or more embodiments.

FIG. 8(a) is a two-dimensional diagram of a phased-array apparatus integration, in accordance with one or more embodiments.

FIG. 8(b) is a three-dimensional diagram of a phased-array apparatus integration, in accordance with one or more embodiments.

FIG. 9(a) is a two-dimensional diagram of a phased-array system, in accordance with one or more embodiments.

FIG. 9(b) is a three-dimensional diagram of a phased-array system, in accordance with one or more embodiments.

FIG. 9(c) is a two-dimensional diagram of an extended phased-array system, in accordance with one or more embodiments.

FIG. 9(d) is a three-dimensional diagram of an extended phased-array system, in accordance with one or more embodiments.

FIG. 10 is a diagram of a structure of another phased-array apparatus, in accordance with one or more embodiments.

FIG. 11(a) is a diagram of a phased-array apparatus integration, in accordance with one or more embodiments.

FIG. 11(b) is a two-dimensional diagram of a phased-array integration, in accordance with one or more embodiments.

FIG. 11(c) is a three-dimensional diagram of a phased-array integration, in accordance with one or more embodiments.

FIG. 12(a) is a two-dimensional diagram of a phased-array system, in accordance with one or more embodiments.

FIG. 12(b) is a three-dimensional diagram of a phased-array system, in accordance with one or more embodiments.

### DESCRIPTION OF EMBODIMENTS

The following describes technical solutions in embodiments of this application with reference to accompanying drawings.

The technical solutions in embodiments of this application may be applied to various communication systems, for example, a global system for mobile communication (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system, or a new radio (NR) system. The technical solutions provided in this application may be further applied to a future communication system, for example, a sixth generation mobile communication system. The technical solutions in embodiments of this application may be further applied to device-to-device (D2D) communication, vehicle-to-everything (V2X) communication, machine-to-machine (M2M) communication, machine type communication (MTC), an internet of things (IoT) communication system, or another communication system.

A terminal device in embodiments of this application may also be referred to as user equipment, an access terminal, a subscriber unit, a subscriber station, a mobile station, a mobile console, a remote station, a remote terminal, a mobile device, a user terminal, a terminal, a wireless communication device, a user agent, a user apparatus, or the like. The terminal device may alternatively be a cellular phone, a cordless phone, a session initiation protocol SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, a terminal device in a future evolved public land mobile communication network (PLMN), or the like. This is not limited in embodiments of this application.

A network device in embodiments of this application may be a device configured to communicate with a terminal device. The network device may be a base transceiver station (BTS) in a global system for mobile communication (GSM) or a code division multiple access (CDMA) system, or may be a NodeB (NB) in a wideband code division multiple access (WCDMA) system, or may be an evolved NodeB (eNB or eNodeB) in an LTE system, or may be a radio controller in a scenario of a cloud radio access network (CRAN). Alternatively, the network device may be a relay station, an access point, an in-vehicle device, a wearable device, a network device in a 5G network, a network device in a future evolved PLMN network, or the like. This is not limited in embodiments of this application.

It should be understood that a phased-array apparatus in this application may be applied to a network device, or may be applied to a terminal device.

To facilitate understanding of the technical solutions of this application, related technical concepts are explained in advance.

### 1. Antenna Array

An antenna array is a radiating system formed by arranging several radiating elements (also referred to as antenna elements) in a direction. Radiating elements that constitute the antenna array are referred to as array elements. The array elements are similar elements or same elements. The similar elements or the same elements mean that all the array elements have a same structural shape, a same size, and a same arrangement direction, that is, have a same directivity pattern factor. The array elements may be symmetric elements, or may be antennas in other forms. A surface of the antenna array is referred to as an antenna array surface.

A radiation field of the antenna array is vector superposition of electromagnetic fields generated by the array elements. A radiation characteristic of the radiation field of the antenna array depends on at least one of an array element type, an array element quantity, an array element arrangement manner, an array element spacing, and amplitude or phase distribution of currents on the array elements.

### 2. Radio Frequency Microsystem

A radio frequency microsystem uses a microsystem heteromaterial/heterostructure integration process technology represented by a micro-nano fabrication technology to implement high-density integration of radio frequency, digital, optoelectronic, energy, and other subsystems, thereby greatly reducing a volume and power consumption of a radio frequency system, significantly improving performance and reliability, and substantially reducing channel costs and life cycle costs. The radio frequency microsystem may be applied to an integrated radio frequency front end and an active array surface, for example, radar, 5G communication, and the Internet of Things, to meet application requirements for miniaturization, lightweight, and multifunctionality. In this application, the radio frequency microsystem is also referred to as a radio frequency front-end microsystem.

### 3. Phased Array

A phased array, also referred to as a phase-compensated array or a delay-compensated array, may be used for both reception and transmission. An operating principle of the phased array is to apply appropriate phase shifts to signals of array elements arranged according to a rule, or apply appropriate delays to signals of array elements, so as to achieve beam steering of the array. A plurality of beams may be obtained by simultaneously performing phase compensation in different directions, or simultaneously performing delay compensation in different directions. Therefore, the array can implement beam scanning within a desired observation space range without mechanical rotation. This is convenient and flexible. In addition, a spatial gain of the phased array is related to a size of the phased array.

A surface of the phased array in this application is referred to as a phased-array surface.

### 4. Redistribution Layer (RDL)

An originally designed integrated circuit (IC) module or chip circuit contact position (I/O pad) is connected to an original metal pad and a new bump or gold pad through a metal wiring process and a bump/through-hole process, to achieve an objective of line redistribution and adapt to different packaging forms. An RDL metal line is mainly made of an electroplated copper material. If required, a copper line may also be electroplated with nickel-gold or nickel-palladium-gold. It should be understood that the RDL is described herein by using a metal material as an example. However, a material of the RDL is not limited thereto, for example, may be silicon, carbon, or another material that can be used for signal transmission in future technology development.

A redistribution wiring is disposed on the redistribution layer, and the redistribution wiring may also be replaced with another name such as wiring or line. The redistribution wiring may be used to construct a transmission path of a signal, or the redistribution wiring may be used to transmit a signal. For example, the redistribution wiring may be a conducting wire or an electrical wire.

In research and design of high-frequency and high-density phased-array integration, high-density interconnection integration, low-loss signal transmission, and highly efficient heat dissipation design are important technical challenges faced by researchers. Especially, as a system operating frequency band gradually increases, a size of an antenna array surface is reduced proportionally with an operating wavelength. However, a size of a radio frequency chip in a radio frequency front-end microsystem, such as a PA, an LNA, a filter, or a switch, is not reduced proportionally with reduction of the operating wavelength. As a result, a total planar area of a high-frequency phased-array front-end chip is usually greater than an area of the antenna array surface. Correspondingly, a planar size of the radio frequency front-end microsystem is usually greater than the size of the antenna array surface. A transmission link from a transceiver chip to an antenna element at an edge of the antenna array surface is relatively long, and a transmission loss of a radio frequency signal is relatively large. In addition, when a phased-array surface is expanded, because a phase-center spacing between adjacent antenna elements of adjacent subarrays exceeds λ/2 (λ is a wavelength corresponding to an operating frequency of the array surface), problems such as grating lobes, elevated sidelobes, and limited array-surface scanning angles are likely to occur in a directivity pattern of the array surface, and performance of a high-frequency phased-array front end is affected.

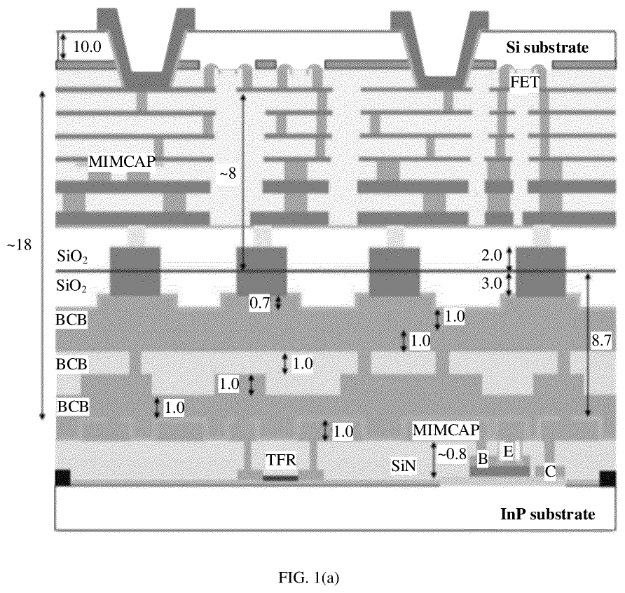

Currently, high-frequency and high-density phased-array integration can be implemented by using the following technologies: a packaging technology based on a multilayer ceramic substrate, a silicon-based micro-electro-mechanical system (MEMS) manufacturing technology, a through-glass-via three-dimensional interconnection technology, and 2.5-dimensional and three-dimensional multi-chip heteromaterial/heterostructure integration solutions of a multilayer printed circuit board (PCB)/package substrate integration technology, in combination with a through-ceramic-via (TCV) process, a through-silicon-via (TSV) process, a through-glass-via (TGV) process, a multilayer RDL process, and the like. For example, FIG. 1(a) to FIG. 1(c) show three high-density interconnection integration designs. FIG. 1(a) is a diagram of wafer-level heteromaterial integration, where high-density integration is implemented on a silicon (Si) substrate and an indium phosphide (InP) substrate. FIG. 1(b) is a diagram of three-dimensional integration using low-temperature co-fired ceramic (LTCC), where a component may be a chip, and high-density integration is implemented on an LTCC substrate in combination with a TCV process. FIG. 1(c) is a diagram of three-dimensional heterostructure integration using a silicon-based MEMS, where multi-chip integration is implemented in combination with a TSV process, an RDL process, and the like.

However, because pins of the foregoing integrated chip are located on a surface of the chip, a current heteromaterial/heterostructure chip integration manner is to place the chip surface parallel to an antenna plane. A planar size of a high-frequency chip is usually greater than a size of an antenna element, and signal transmission between the chip and a previous-stage link or a next-stage link involves complex transmission over relatively long links in directions parallel to and perpendicular to the chip surface. Therefore, even if a three-dimensional multilayer integration manner is used, a total planar area of multiple final-stage chips of the radio frequency front end is usually greater than the area of the antenna array surface, a transmission link from a chip having a receiving and/or sending function to an edge element on the array surface is relatively long, and a transmission loss of a radio frequency signal is relatively large. When the integrated chip includes multiple chips with different functions, signal transmission paths of the multiple chips are also relatively complex (for example, a parallel RDL combined with a vertical TCV/TGV/TSV).

In addition, during expansion of the antenna array surface or use of subarray tiling, the foregoing integration manner usually causes a phase-center spacing between adjacent antenna elements of adjacent subarrays to exceed λ/2. As a result, problems such as grating lobes, elevated sidelobes, and limited scanning angles occur in a directivity pattern of the combined antenna array surface.

In addition, in a horizontal multilayer chip integration manner, a heat dissipation manner of an upper-layer chip is limited by space and a material, and a heat dissipation design is limited, which imposes a great constraint on use of three-dimensional integration of a final-stage chip with relatively high power consumption. For example, a final-stage chip with relatively high power is close to a bottom layer of the integrated package for heat dissipation. However, in this design, a transmission path from the final-stage chip to an antenna is relatively long, and a loss is correspondingly increased. Alternatively, in the integration design, the final-stage chip is integrated at a top layer, depending on an additional special heat dissipation design, but this increases complexity and the size of the high-density integrated system.

To enable a planar size of the integrated radio frequency front-end microsystem to match a size of the phased-array antenna array surface, one transceiver chip channel may be used to drive multiple passive antenna elements, so as to reduce a quantity of final-stage chips and a total planar area.

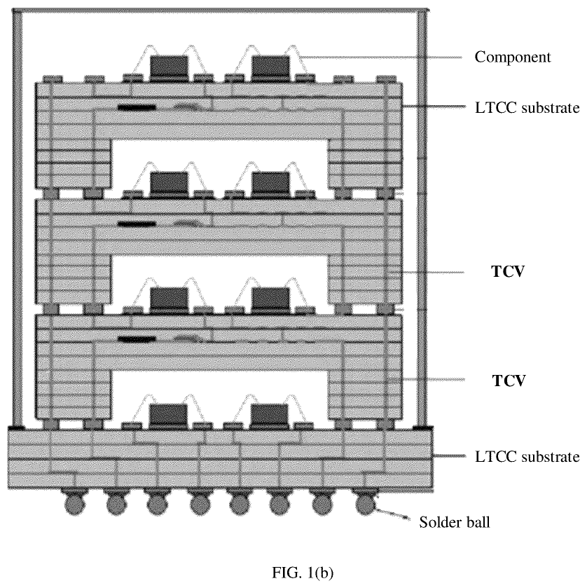

Alternatively, a sparse array layout manner is used on the antenna array surface, to optimize a layout of array elements, and increase a size of an antenna array envelope, so that the size of the antenna array surface matches the planar size of the front-end microsystem. FIG. 2 is a two-dimensional diagram of the sparse array layout on the antenna array surface. A horizontal axis is column ordering of array elements, and a vertical axis is row ordering of array elements. However, when one transceiver chip channel drives multiple passive antenna elements, total microwave output power is reduced, equivalent isotropically radiated power (EIRP) of the phased-array system is reduced, and a communication distance of the system is reduced. In addition, due to the one-to-many drive design, no phase adjustment can be implemented between multiple antenna elements driven by one chip channel, and a beam scanning capability of the phased-array antenna array is limited. The sparse array layout design of the antenna array surface also limits the scanning capability of the array.

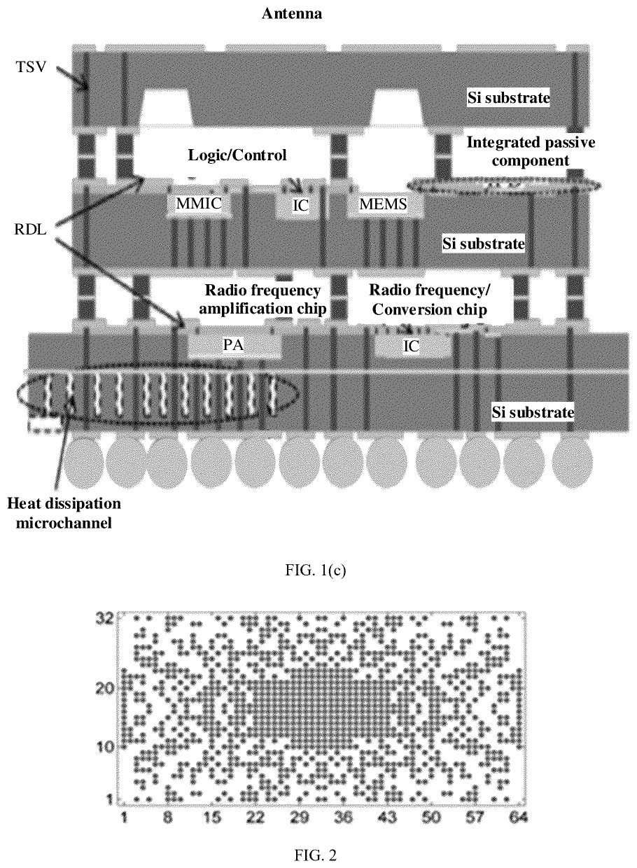

In addition, to reduce a volume of a package structure, currently, horizontal and vertical cavities can be formed on horizontal and vertical silicon wafers by using an etching process. Different chips are mounted in silicon-based cavities by attaching films to the chips. For example, a package unit is vertically mounted by using a die attach film (DAF) (211), to improve heat dissipation performance of the entire package structure and structural strength of the entire package structure. As shown in FIG. 3, different chips are distributed in horizontal or vertical cavities, but a horizontal size of the chip integrated package structure still needs to be reduced. Moreover, a transmission path between a chip (104) and a next-stage link needs to cross another silicon wafer (201), resulting in a relatively long transmission path (which electrically connects the chip 104, a parallel-chip RDL 105, a solder ball 106, a vertical-chip RDL 209, a vertical TSV 202, a horizontal RDL 206, and a second solder ball 212). In addition, in the horizontal/vertical staggered layered integration of multiple types of chips, heat of a chip can only be transferred downward through a silicon wafer substrate, which increases a heat dissipation burden of a horizontally integrated chip (205) located below the chip 104.

In view of this, this application provides a phased-array apparatus. In the apparatus, chips are densely integrated in a direction perpendicular to an antenna array surface, so that a size of a phased-array surface matches a size of the antenna array surface, thereby effectively shortening a signal transmission path.

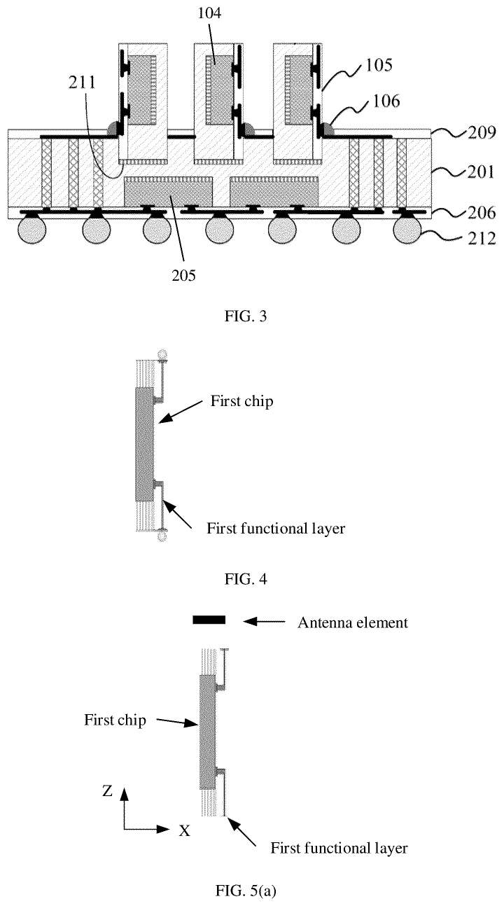

As shown in FIG. 4, the phased-array apparatus includes a first chip, and the first chip is configured to send and/or receive a first signal.

The first chip may be configured to send a signal, or the first chip may be configured to receive a signal, or the first chip may be configured to send a signal and receive a signal.

The first signal may be a radio frequency signal. For example, the first signal may be a microwave signal. For example, the first signal may be used for control. For example, the first signal is a control signal of the first chip. Alternatively, the first signal may be a logic signal.

It should be understood that the first signal is sent and/or received by the first chip, and a type or a function of the first signal is related to a function of the first chip.

The first chip may be a microwave chip.

For example, the first chip is a monolithic microwave integrated circuit (MMIC) chip. The MMIC may include a low noise amplifier (LNA), a power amplifier, a frequency mixer, an upconverter, a detector, a modulator, a voltage-controlled oscillator (VCO), a phase shifter, a switch, an MMIC transceiver front end, even an entire transmit/receive (T/R) component (a transceiver system), or the like.

The first chip may alternatively be an integrated circuit (IC) chip.

The first chip may alternatively be a micro-electro-mechanical system (MEMS) chip.

For example, when the first chip is a microwave chip, the signal (that is, the first signal) sent and/or received by the first chip is a microwave signal. When the first chip includes a control function, the signal received by the first chip may be a control signal.

It should be understood that the foregoing examples are used merely as examples of the first chip and the first signal, and the function of the first chip and the type of the first signal are not limited in this application. The technical solutions of this application are also applicable to another chip or a chip in future technology development.

The phased-array apparatus further includes a first functional layer. A redistribution wiring is disposed on the first functional layer. For the redistribution wiring, refer to the foregoing description. Details are not described again.

The redistribution wiring is configured to connect the first chip and an antenna element. In other words, the first functional layer is configured to connect the first chip and the antenna element. The first functional layer is disposed on a first surface of the first chip. In other words, the redistribution wiring is disposed on the first surface of the first chip.

In FIG. 4, a plane on which a long side of the first chip is located is the first surface of the first chip.

A normal direction of a plane on which the first surface of the first chip is located is perpendicular to a normal direction of a plane on which a surface of the antenna element is located.

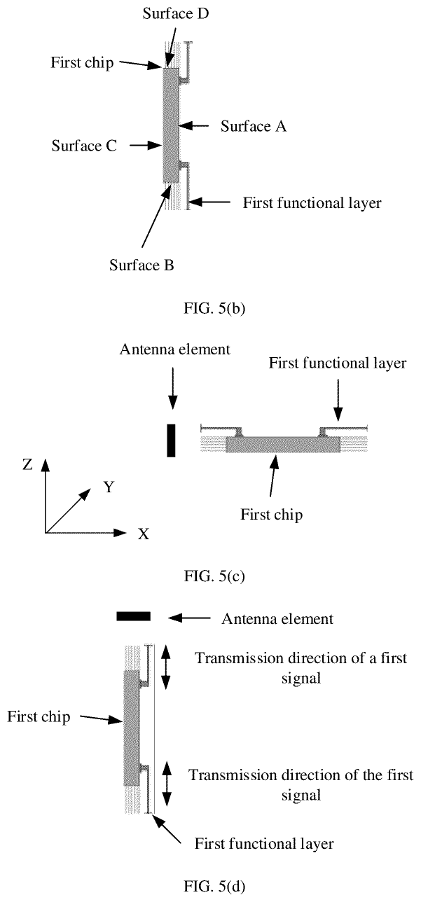

FIG. 5(a) to FIG. 5(d) describe the first surface of the first chip and signal transmission by using a relative position relationship between the first chip and the antenna element.

As shown in FIG. 5(a), the antenna element is disposed above the phased-array apparatus, the plane on which the surface of the antenna element is located is a plane on which an X-axis is located, and the plane on which the first surface of the first chip is located is a plane on which a Z-axis is located.

It may be understood that a cross-section of the chip may be in various shapes, such as a square, a circle, and an ellipse, and a plane perpendicular to the surface of the antenna element is the plane on which the first surface of the first chip is located.

For example, as shown in FIG. 5(b), the first chip has a plurality of surfaces, including a surface A, a surface B, a surface C, and a surface D, and the first surface of the first chip is the surface A or the surface C.

It should be further understood that the first surface of the first chip is related to a relative position between the first surface of the first chip and the plane on which the surface of the antenna element is located, and is not constrained by locations of planes on which the X-axis, the Y-axis, and the Z-axis are located. In other words, the plane on which the first surface of the first chip is located is not necessarily a plane on which a coordinate axis is located.

For example, as shown in FIG. 5(c), the antenna element is disposed in a Z-axis direction, the plane on which the surface of the antenna element is located is the plane on which the Z-axis is located, and the plane perpendicular to the plane on which the surface of the antenna element is located is the plane on which the X-axis is located. In this case, the first surface of the first chip is the surface A.

The redistribution wiring disposed on the first functional layer is laid along the first surface of the first chip.

The redistribution wiring may be configured to transmit a signal, for example, configured to transmit the first signal. A transmission direction of the first signal is parallel to the normal direction of the plane on which the surface of the antenna element is located. In other words, as shown in FIG. 5(d), the transmission direction of the first signal is perpendicular to the plane on which the surface of the antenna element is located.

Optionally, the redistribution wiring on the first functional layer may be further configured to connect the first chip and a primary link. For example, the first chip is connected to the antenna element by using the redistribution wiring on the first functional layer, and the first chip is connected to the primary link by using the redistribution wiring on the first functional layer.

For example, the primary link may be a microwave signal transmitting chip, or the primary link may be a microwave signal amplification chip, or the primary link may be a microwave signal receiving secondary amplification chip.

In a possible implementation, the first functional layer is an RDL.

In a possible implementation, the redistribution wiring may be a metal redistribution wiring.

Optionally, the phased-array apparatus may further include a second functional layer. The second functional layer may be configured to dissipate heat.

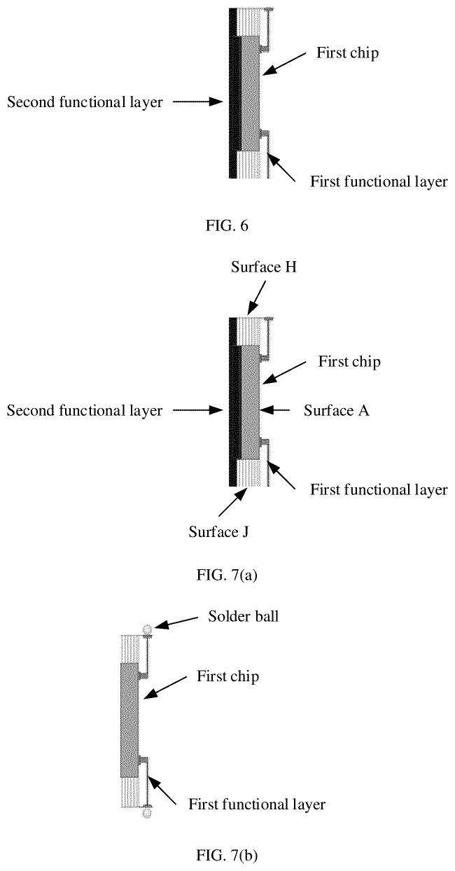

As shown in FIG. 6, the second functional layer is disposed on a second surface of the first chip.

A normal direction of the first surface of the first chip coincides with a normal direction of the second surface of the first chip, and a distance exists between the first surface of the first chip and the second surface of the first chip. In other words, the second surface of the first chip is parallel to the first surface of the first chip.

For example, as shown in FIG. 5(b), when the first surface of the first chip is the surface A, the second surface of the first chip is the surface C. Alternatively, when the first surface of the first chip is the surface C, the second surface of the first chip is the surface A.

In a possible implementation, a material of the second functional layer is metal, for example, may be copper.

It should be understood that copper is used as an example of the material of the second functional layer. Alternatively, the second functional layer may be dense metal vias or a material with high thermal conductivity and compatible with an integration process.

In addition, the phased-array apparatus may further include a first functional module, and the first functional module is configured to electrically connect to the first chip. The first functional module is disposed on a first surface of the phased-array apparatus, and a normal direction of the first surface of the phased-array apparatus is perpendicular to the normal direction of the first surface of the first chip.

The electrical connection may be understood as connecting different apparatuses or different components by using an electrical wire or a conducting wire, to allow a current to flow.

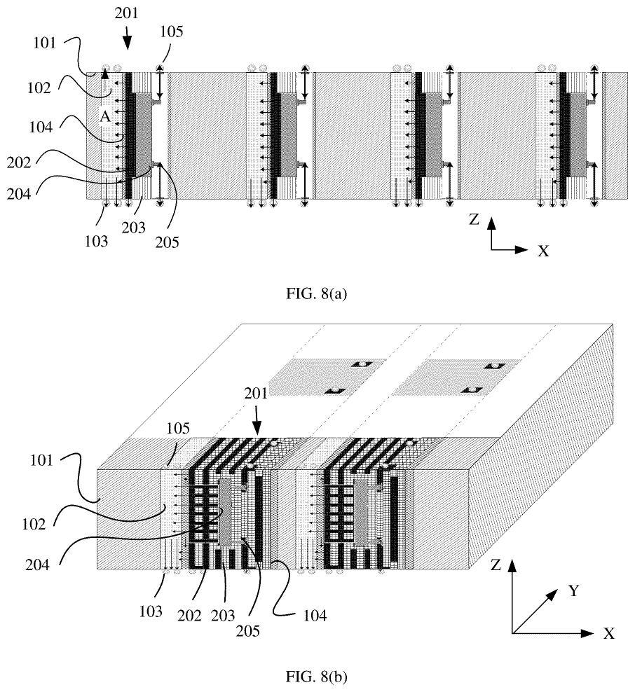

As shown in FIG. 7(a), the first surface of the phased-array apparatus includes a surface H and a surface J, and the first surface of the first chip is the surface A. The first functional module may be disposed on both the surface H and the surface J. The first functional module is electrically connected to the first chip. For example, the first chip is connected to the antenna element by using the first functional layer and the first functional module, and/or the first chip is connected to the primary link by using the first functional layer and the first functional module.

In a possible implementation, the first functional module includes at least one solder ball. As shown in FIG. 7(b), the at least one solder ball is disposed on the surface H and the surface J.

It should be understood that the solder ball is used merely as an example of the first functional module. Alternatively, the first functional module may be a stripline-microstrip-waveguide transition structure or in another ball-less electrical connection form.

To help clearly understand the phased-array apparatus provided in this application, the following provides a possible implementation by using an example in which the first chip is a final-stage chip, the first functional layer is an RDL, the second functional layer is a copper block, and the first functional module is a solder ball.

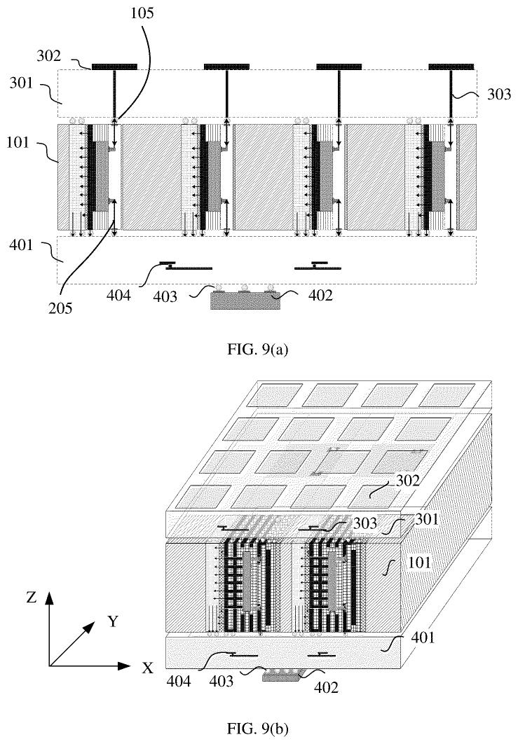

FIG. 8(a) is a two-dimensional diagram of a phased-array apparatus integration. A multilayer package integrated board 101 integrates multiple vertical chip package substrate modules 201. The vertical chip package substrate module 201 vertically integrates, by hot-pressing and embedding through a multilayer package substrate 203, a phased-array final-stage chip 204, a parallel RDL 205 on a surface of the chip 204 (that is, the first surface of the first chip), and a heat dissipation copper block 202 embedded on a back side of the chip 204 (that is, the second surface of the first chip).

The phased-array final-stage chip 204 implements, in a direction parallel to the surface of the chip, ultra-short path interconnection with previous-stage and next-stage links and low-loss signal transmission by using the parallel RDL 205 on the surface of the chip and a solder ball 105.

For example, an arrow B in the figure is a possible transmission direction of a signal. A corresponding interface of the final-stage chip 204 is connected to a feed port of an antenna array surface, and a corresponding interface of the final-stage chip 204 is connected to a control link and a power supply link, and is interconnected with a drive-stage link (that is, a primary link).

It should be understood that in FIG. 8(a), four vertical chip package substrate modules are used as an example of integration. However, this application is not limited thereto. For example, a quantity of vertical chip package substrate modules included in an integrated system is not limited in this application.

The vertical chip package substrate module includes the foregoing phased-array apparatus. In other words, the foregoing phased-array apparatus may be used as a minimum unit of integration. The vertical chip package substrate module may be used as a minimum unit of integration in a process.

FIG. 8(a) further illustrates heat dissipation by a copper block. The copper block embedded on the back side of the final-stage chip 204 can dissipate, in at least three directions (as shown by an arrow A in the figure), heat generated by the chip. Because the chip is vertically disposed, a surface on which a long side of the chip is located is in full contact with the copper block, thereby increasing a heat dissipation area.

In addition, vertical integration of chips saves horizontal occupied space. When the chips are integrated in multiple layers in the vertical direction, a strip-shaped highly thermally conductive metal layer integrated in the vertical direction may be embedded on a back side of each chip in the vertical multiple layers of chips. In this way, a thermal connection is established between the phased-array final-stage chip 204, the heat dissipation copper block 202 at the bottom of the chip, a high-thermal-conductivity thermal pad 104, a high-thermal-conductivity heat dissipation copper layer 102, and dense heat dissipation solder balls 103, so that highly efficient heat dissipation can be implemented for the multiple layers of chips in a phased-array front-end microsystem. The thermal pad 104 may be made of a high-thermal-conductivity material such as a thermal adhesive or an indium foil. The strip-shaped highly thermally conductive metal layer in the vertical direction, designed in more ample three-dimensional space, can implement rapid and highly efficient spreading and dissipation of heat from each final-stage chip.

A typical thickness of a chip is tens to hundreds of μm, and a typical thickness of an RDL is up to tens of μm, while a typical planar size of the chip is several mm. Therefore, after the chip is vertically integrated, a thickness of the chip in the horizontal direction (an X-axis direction in FIG. 8(a)) is 100 μm, which is merely 1/10 (or even smaller) of a thickness of a horizontally integrated chip. Therefore, a problem that a total planar area occupied by a front-end chip integrated in a high-frequency phased-array front-end microsystem is greater than an area of the antenna array surface can be resolved, and a planar size of the phased-array front-end microsystem can match a size of the antenna array surface. During expansion of a high-frequency (such as millimeter-wave) phased-array antenna array surface or use of subarray tiling, a phase-center spacing between adjacent antenna elements of adjacent phased-array subarrays is less than or equal to λ/2, which can effectively ensure a good beam scanning capability of the array after high-frequency phased-array antenna subarray surfaces are expanded or tiled.

In addition, because a chip is integrated in a direction perpendicular to a surface of an antenna element (referred to as vertical integration of the chip in this specification), more chips can be integrated in a same planar area. Therefore, the phased array can achieve higher transmit power and a higher EIRP, a communication/sensing distance of the phased array can be increased, and a communication/sensing capability of a high-frequency phased-array system can be further improved.

FIG. 8(b) is a three-dimensional diagram of a phased-array apparatus integration. In the diagram, two vertical chip package substrate modules are used as an example. In an X-axis direction, positions of the two substrate modules are different, and are respectively (1, 1) and (n, 1). In a Z-axis direction, the two substrate modules are at a same position. In other words, different substrate modules are integrated in the X-axis direction.

It should be understood that integration of the substrate modules in the Z-axis direction is not shown in the figure, but a manner of integrating the substrate modules should not be limited. For example, integration of the substrate modules may be determined based on an application requirement. For example, the substrate modules may be integrated in the Z-axis direction. Alternatively, the substrate modules may be integrated in both the Z-axis direction and the X-axis direction.

In other words, the phased-array apparatus may serve as a core part of a substrate module, and the substrate module may be integrated as a unit of integration according to a specified direction or rule. After being integrated, the substrate modules and other components such as an antenna element may together constitute a phased-array front-end microsystem.

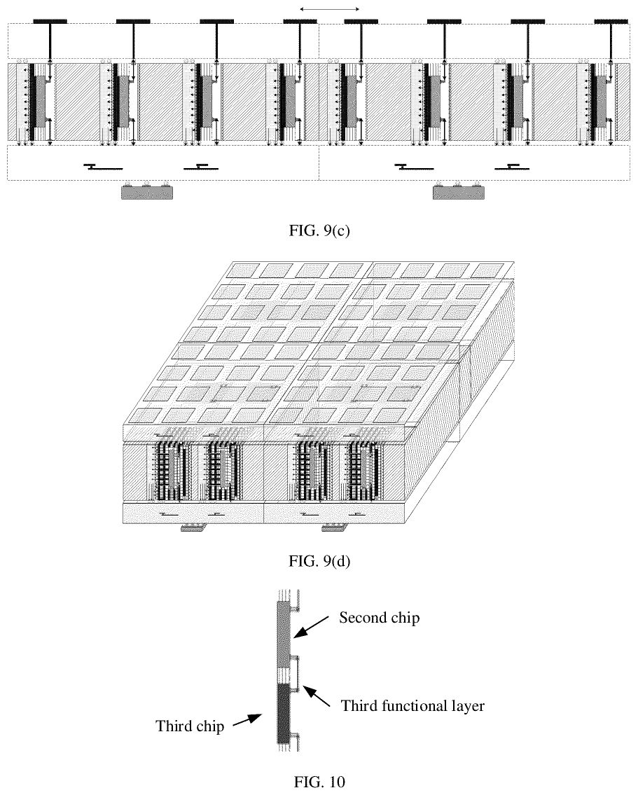

FIG. 9(a) is a two-dimensional diagram of a phased-array system.

For example, the phased-array system may be a phased-array front-end microsystem. For the phased-array system in the following descriptions, refer to descriptions herein. Details are not described again.

The phased-array system includes an antenna array surface 301, an array-scale antenna element 302, an antenna array surface feeding network 303, a PCB mother board 401, and the foregoing phased-array apparatus.

Nodes traversed by an upward (in an upward direction in the figure) signal transmission link of a chip are: a parallel RDL 205 on a surface of the chip, a solder ball 105, the antenna array surface feeding network 303, and the antenna element 302.

Nodes traversed by a downward (in a downward direction in the figure) signal transmission link of the chip are: the parallel RDL 205 on the surface of the chip, the solder ball 105, a PCB motherboard multilayer wiring 404, a PCB motherboard solder ball 403, and a chip 402, where the chip 402 may be a microwave primary drive chip, a digitally controlled field programmable gate array (FPGA) chip, a power supply chip, or the like.

FIG. 9(b) is a three-dimensional diagram of a phased-array system. For a related structure, refer to FIG. 9(a). Details are not described again.

FIG. 9(c) is a two-dimensional diagram of an extended phased-array system. It is equivalent to extending and integrating FIG. 9(a) in an X-axis direction. For a related structure, refer to FIG. 9(a). Details are not described again. It can be learned that a phase-center spacing between adjacent antenna elements of adjacent subarrays is less than or equal to λ/2.

FIG. 9(d) is a three-dimensional diagram of an extended phased-array system. For a related structure, refer to FIG. 9(a). Details are not described again.

A chip is integrated in a direction perpendicular to a surface of an antenna element, so that a phased-array front-end microsystem can integrate more final-stage chips in a same planar area. For example, given the same planar area (an antenna array surface scale), compared with a phased array with horizontally integrated chips in a 1:N drive design (N is a quantity of passive antenna elements corresponding to one transceiver chip channel), a phased-array front-end microsystem with vertically integrated chips can implement at least 1:N/2 driving (1:1 driving in one planar dimension direction (an X-axis direction in FIG. 9(a) to FIG. 9(d)), and 1:N/2 driving in another planar dimension direction (a Y-axis direction in FIG. 9(a) to FIG. 9(d))). Therefore, a quantity of final-stage chips can be correspondingly doubled, and transmit power and EIRP of a high-frequency phased array can also be doubled. If a size of a final-stage chip in one planar dimension direction is less than a size of an antenna element, the front-end microsystem with vertically integrated chips can implement a 1:1 driving relationship between the chip channel and antenna elements, the quantity of final-stage chips can be correspondingly increased by a factor of N, and the transmit power and EIRP of the high-frequency phased array can also be increased by a factor of N.

This application further provides a phased-array apparatus. Compared with the foregoing phased-array apparatus, the phased-array apparatus may incorporate more chips, to be applicable to more application scenarios.

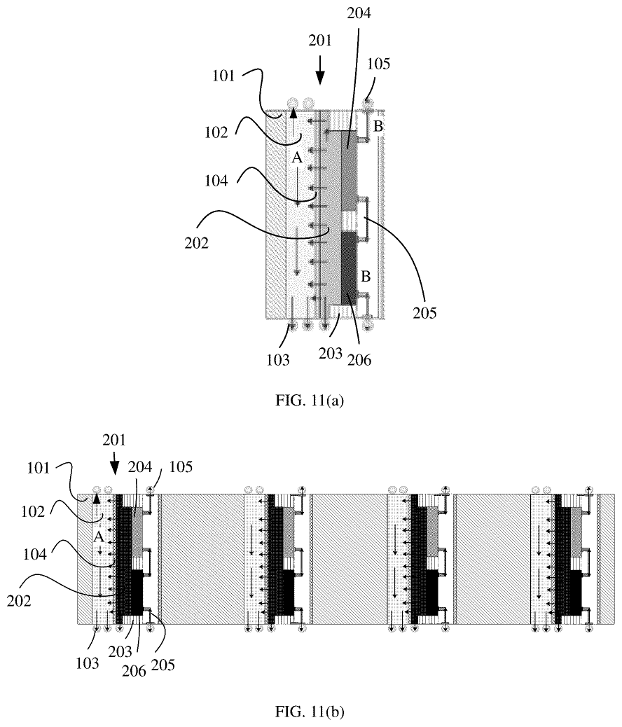

In a possible implementation, a structure of the phased-array apparatus is illustrated in FIG. 10. The phased-array apparatus includes a second chip, and the second chip is configured to send and/or receive a second signal. The phased-array apparatus further includes a third chip, and the third chip is configured to send and/or receive a third signal.

The phased-array apparatus further includes a third functional layer, where a redistribution wiring is disposed on the third functional layer, and the redistribution wiring is configured to connect the second chip, the third chip, and an antenna element.

Optionally, the redistribution wiring is further configured to connect the third chip and a primary link.

The third functional layer is disposed on a first surface of the second chip and a first surface of the third chip, a normal direction of a plane on which the first surface of the second chip is located is perpendicular to a normal direction of a plane on which a surface of the antenna element is located, and a normal direction of a plane on which the first surface of the third chip is located is perpendicular to the normal direction of the plane on which the surface of the antenna element is located. In other words, the second chip and the third chip may share the same third functional layer. Alternatively, the third functional layer may include two parts, where one part is disposed on the first surface of the second chip, and the other part is disposed on the first surface of the third chip.

For the first surface of the second chip, refer to the description of the first surface of the first chip in FIG. 4. Details are not described herein again. A position of the first surface of the third chip is different from a position of the first surface of the second chip, but the plane on which the first surface of the third chip is located is the same as the plane on which the first surface of the second chip is located.

For the third functional layer, refer to the description of the first functional layer. For the redistribution wiring on the third functional layer, refer to the description of the redistribution wiring on the first functional layer. Details are not described herein again.

A transmission direction of the second signal is parallel to the normal direction of the plane on which the surface of the antenna element is located, and a transmission direction of the third signal is parallel to the normal direction of the plane on which the surface of the antenna element is located. For the transmission direction of the second signal, refer to the description of the transmission direction of the first signal in FIG. 4. For the second signal and the third signal, refer to the description of the first signal in FIG. 4. Details are not described herein again. The transmission direction of the third signal may be the same as the transmission direction of the second signal.

The second chip and the third chip are at a same position in a normal direction of the first surface of the second chip, and the second chip and the third chip are at different positions in a direction parallel to the first surface of the second chip. As shown in FIG. 10, the second chip and the third chip are at different positions on a Z-axis, and the second chip and the third chip are at a same position on an X-axis.

Optionally, the phased-array apparatus further includes a fourth functional layer. The fourth functional layer is disposed on a second surface of the second chip and a second surface of the third chip, the normal direction of the first surface of the second chip coincides with a normal direction of the second surface of the second chip, a normal direction of the first surface of the third chip coincides with a normal direction of the second surface of the third chip, a distance exists between the first surface of the second chip and the second surface of the second chip, and a distance exists between the first surface of the third chip and the second surface of the third chip.

The fourth functional layer may be configured to dissipate heat.

For the second surface of the second chip and the second surface of the third chip, refer to the description of the second surface of the first chip in FIG. 5(a) to FIG. 5(d). For the second chip and the third chip, refer to the description of the first chip in FIG. 4. Details are not described herein again. Functions of the second chip and the third chip may be the same or different.

For the fourth functional layer, refer to the foregoing description of the second functional layer. Details are not described again.

Optionally, the phased-array apparatus further includes a second functional module, the second functional module is configured to electrically connect to the second chip, the second functional module is disposed on a first surface of the phased-array apparatus, and a normal direction of the first surface of the phased-array apparatus is perpendicular to the normal direction of the first surface of the second chip.

For the first surface of the phased-array apparatus, refer to the description of the first surface of the phased-array apparatus in FIG. 5(a) to FIG. 5(d). For the second functional module, refer to the description of the first functional module in FIG. 4. Details are not described again.

It should be understood that FIG. 10 shows only two types of chips. However, this application is not limited thereto. For example, the phased-array apparatus may integrate two, three, or four chips in a Z-axis direction, and a quantity of chips is not limited.

To help clearly understand the phased-array apparatus provided in this application, the following provides a possible implementation by using an example in which the second chip is a final-stage chip, the third chip is a drive (stage) chip, the third functional layer is an RDL, the fourth functional layer is a copper block, and the second functional module is a solder ball.

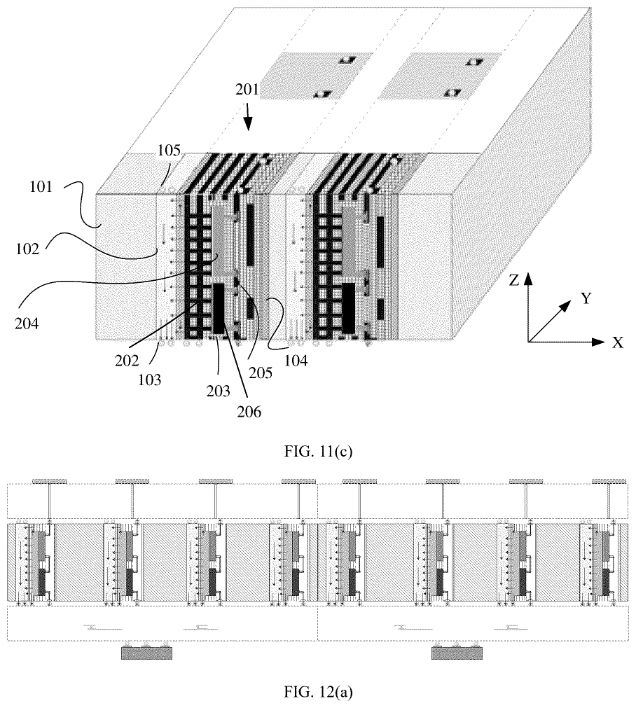

FIG. 11(a) is a diagram of a phased-array apparatus package. In the figure, two functional chips (for example, a final-stage chip 204 and a drive-stage chip 206 of a phased-array microsystem) are vertically integrated in each vertical chip package substrate module 201 by using an embedded integration process in the package substrate. By properly selecting a thickness of a core board of a multilayer package substrate 203, it is ensured that two functional chips 204 and 206 with different thicknesses are buried at a same horizontal position (as shown in FIG. 11(a) to FIG. 11(c), X-axis coordinates of the chips 204 and 206 are the same). Through a shared parallel RDL 205 on a chip surface, the drive-stage chip 206 and the final-stage chip 204 implement ultra-short path interconnection and low-loss transmission of a signal (for example, a millimeter-wave signal) in a direction parallel to the chip surface. In the figure, an arrow B indicates a signal transmission direction, and an arrow A indicates a heat dissipation direction. For illustrations represented by other reference numerals, refer to descriptions of same reference numerals in FIG. 8(a) to FIG. 8(b).

FIG. 11(b) is a two-dimensional diagram of a phased-array integration. For a related structure, refer to the description of FIG. 11(a). In the figure, four phased-array apparatuses are integrated as an example, but a quantity of phased-array apparatuses should not be limited.

FIG. 11(c) is a three-dimensional diagram of a phased-array integration. For a related structure, refer to the description of FIG. 11(a). In the figure, two phased-array apparatuses are integrated as an example, but a quantity of phased-array apparatuses should not be limited.

It should be understood that integration of the substrate modules in the Z-axis direction is not shown in the figure, but a manner of integrating the substrate modules should not be limited. For example, integration of the substrate modules may be determined based on an application requirement. For example, the substrate modules may be integrated in the Z-axis direction. Alternatively, the substrate modules may be integrated in both the Z-axis direction and the X-axis direction.

In other words, the phased-array apparatus may be used as a core part of a substrate module, and the substrate module may be integrated as a unit of integration according to a specified direction or rule. After being integrated, the substrate modules and other components such as an antenna element may together constitute a phased-array system.

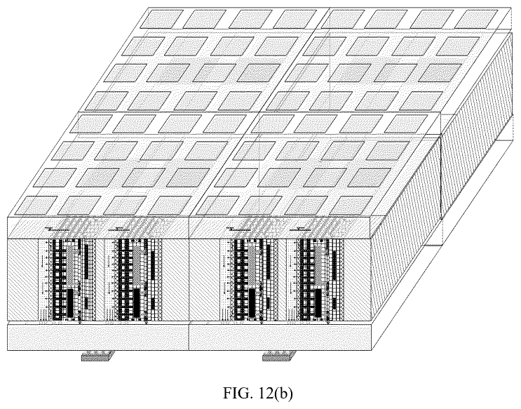

FIG. 12(a) is a two-dimensional diagram of a phased-array system. For a related structure, refer to the description of FIG. 9(a). The phased-array system includes two phased-array integrations, and each phased-array integration includes four phased-array apparatuses. However, a quantity of phased-array integrations or phased-array apparatuses included in the phased-array system is not limited in this application.

For example, the phased-array system may be a phased-array front-end microsystem.

FIG. 12(b) is a three-dimensional diagram of a phased-array system. For a related structure, refer to the description of FIG. 9(b). In this figure, phased-array apparatuses may be integrated in different directions of the phased-array system.

A difference between FIG. 12(a) to FIG. 12(b) and FIG. 9(a) to FIG. 9(d) lies in a quantity of chips in a single phased-array apparatus.

According to a phased-array microwave link design, a same quantity of drive-stage chips 206 may be vertically integrated with a same quantity of final-stage chips 204 in a one-to-one manner, or drive-stage chips 206 may be merged in a Y-axis direction, to achieve a one-to-N correspondence between the drive-stage chips 206 and the final-stage chips 204 (N is a quantity of final-stage chips 204 corresponding to one drive-stage chip 206).

In addition, in a multilayer chip integration architecture in a vertical direction, a strip-shaped highly thermally conductive metal layer 102 integrated in the vertical direction is embedded on a back side of each chip, so that integrated and highly efficient heat dissipation can be implemented for multiple layers of chips in the vertical direction (a Z-axis direction in FIG. 12(a) to FIG. 12(b)) of a high-frequency phased-array front-end microsystem. An integration position of a chip (for example, a final-stage chip 204 in the example) with relatively high power consumption is no longer heavily constrained. In this way, the high-frequency phased-array front-end microsystem can implement more complete phased-array microwave link functions in a smaller planar integration area.

According to the solutions in this application, a planar size of a high-density integrated front-end microsystem can be significantly reduced without significantly increasing system costs or changing an existing architecture of a phased-array front-end microsystem; and ultra-short path interconnection and low-loss transmission of millimeter-wave signals between an integrated chip and a previous-stage link and a next-stage link are implemented by relying solely on signal transmission in a direction parallel to a chip surface. Moreover, a good beam scanning capability can be maintained after expansion or tiling of phased-array subarray surfaces, higher transmit power and a higher EIRP can be achieved within a same area, and highly efficient heat dissipation is implemented for front-end vertical multiple layers of chips.

The technical solutions of this application may be applied to the field of communication technologies, for example, may be applied to the semiconductor field, such as the microwave chip field, the millimeter-wave high-density integrated packaging field, or the millimeter-wave phased-array front-end microsystem field.

This application may be applied to an array apparatus that requires a phased array in a high-frequency millimeter-wave or high-frequency terahertz (THz) wave band, for use in various terminals, base stations, or the like in communication and communication-sensing integrated scenarios.

It should be understood that microwave is used as an example of a signal frequency band herein, but this application is not limited thereto. For example, the technology may also be applied to a phased-array integration design of a higher frequency band or another frequency band.

An embodiment of this application further provides an apparatus. The apparatus may include any phased-array apparatus in the foregoing embodiments. For example, the apparatus may be a terminal, or may be a network device. This is not limited in this application.

A person of ordinary skill in the art may be aware that units and algorithm steps in the examples described with reference to embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the foregoing apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely example implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A phased-array apparatus, comprising:
a first chip configured to one or more of send or receive a first signal; and
a first functional layer on a first surface of the first chip, wherein
the first chip is connected to an antenna element by way of a redistribution wiring on the first functional layer,
the redistribution wiring extends along the first surface of the first chip, and
a normal direction of a first plane on which the first surface of the first chip is located is perpendicular to a normal direction of a second plane on which a surface of the antenna element is located.

2. The phased-array apparatus according to claim 1, further comprising:
a first functional module configured to electrically connect to the first chip, wherein the first functional module is on a first surface of the phased-array apparatus, and a normal direction of the first surface of the phased-array apparatus is perpendicular to a normal direction of the first surface of the first chip.

3. The phased-array apparatus according to claim 2, wherein the first functional module comprises at least one solder ball.

4. The phased-array apparatus according to claim 2, further comprising:
a second functional layer on a second surface of the first chip, wherein the normal direction of the first surface of the first chip coincides with a normal direction of the second surface of the first chip, and a distance exists between the first surface of the first chip and the second surface of the first chip.

5. The phased-array apparatus according to claim 4, wherein the second functional layer is configured to dissipate heat.

6. The phased-array apparatus according to claim 5, wherein a material of the second functional layer is metal.

7. The phased-array apparatus according to claim 1, wherein the redistribution wiring is further configured to connect the first chip and a primary link.

8. A phased-array apparatus, comprising:
a second chip configured to one or more of send or receive a second signal;
a third chip configured to one or more of send or receive a third signal; and
a third functional layer on a first surface of the second chip and a first surface of the third chip,
wherein
the second chip and the third chip are connected to an antenna element by way of a redistribution wiring on the third functional layer,
a normal direction of a first plane on which the first surface of the second chip is located is perpendicular to a normal direction of a second plane on which a surface of the antenna element is located,
a normal direction of a third plane on which the first surface of the third chip is located is perpendicular to the normal direction of the second plane on which the surface of the antenna element is located,
the redistribution wiring extends along the first surface of the second chip, and
the redistribution wiring extends along the first surface of the third chip.

9. The phased-array apparatus according to claim 8, wherein
the second chip and the third chip are equally separated from the first surface of the second chip in a first direction normal to the first surface of the second chip, and
the second chip and the third chip are at different positions in a second direction parallel to the first surface of the second chip.

10. The phased-array apparatus according to claim 8, further comprising:
a fourth functional layer on a second surface of the second chip and a second surface of the third chip,
wherein the normal direction of the first surface of the second chip coincides with a normal direction of the second surface of the second chip, a normal direction of the first surface of the third chip coincides with a normal direction of the second surface of the third chip, a first distance exists between the first surface of the second chip and the second surface of the second chip, and a second distance exists between the first surface of the third chip and the second surface of the third chip.

11. The phased-array apparatus according to claim 10, wherein the fourth functional layer is configured to dissipate heat.

12. The phased-array apparatus according to claim 11, wherein a material of the fourth functional layer is metal.

13. The phased-array apparatus according to claim 8, further comprising:
a second functional module configured to electrically connect to the second chip, wherein the second functional module is on a first surface of the phased-array apparatus, and a normal direction of the first surface of the phased-array apparatus is perpendicular to the normal direction of the first surface of the second chip.

14. The phased-array apparatus according to claim 13, wherein the second functional module comprises at least one solder ball.

15. The phased-array apparatus according to claim 8, wherein the redistribution wiring is further configured to connect the third chip and a primary link.

16. A phased-array system, comprising:
at least one first phased-array apparatus; and
at least one second phased-array apparatus,
wherein
the at least one first phased-array apparatus is connected to an antenna element,
the first phased-array apparatus comprises:
a first chip configured to one or more of send or receive a first signal; and
a first functional layer on a first surface of the first chip,
the first chip is connected to the antenna element by way of a first redistribution wiring on the first functional layer, the redistribution wiring extends along the first surface of the first chip, and a normal direction of a first plane on which the first surface of the first chip is located is perpendicular to a normal direction of a second plane on which a first surface of the antenna element is located;
the at least one second phased-array apparatus is connected to the antenna element,
the at least one second phased-array apparatus comprises:
a second chip configured to one or more of send or receive a second signal;
a third chip configured to one or more of send or receive a third signal; and
a third functional layer on a first surface of the second chip and a first surface of the third chip,
the second chip and the third chip are connected to the antenna element by way of a second redistribution wiring on the third functional layer,
a normal direction of a third plane on which the first surface of the second chip is located is perpendicular to a normal direction of a fourth plane on which a second surface of the antenna element is located,
a normal direction of a fifth plane on which the first surface of the third chip is located is perpendicular to the normal direction of the fourth plane on which the surface of the antenna element is located,
the redistribution wiring extends along the first surface of the second chip, and
the redistribution wiring extends along the first surface of the third chip.

17. The phased-array system according to claim 16, wherein a phase-center spacing between adjacent antenna elements is less than or equal to λ/2, and λ is a wavelength corresponding to an operating frequency of the antenna element.

18. The phased-array system according to claim 16, wherein the at least one first phased-array apparatus further comprises:
a second functional layer on a second surface of the first chip, wherein the normal direction of the first surface of the first chip coincides with a normal direction of the second surface of the first chip, and a first distance exists between the first surface of the first chip and the second surface of the first chip.

19. The phased-array system according to claim 18, wherein the at least one second phased-array apparatus further comprises:
a fourth functional layer on a second surface of the second chip and a second surface of the third chip,
wherein the normal direction of the first surface of the second chip coincides with a normal direction of the second surface of the second chip, a normal direction of the first surface of the third chip coincides with a normal direction of the second surface of the third chip, a second distance exists between the first surface of the second chip and the second surface of the second chip, and a third distance exists between the first surface of the third chip and the second surface of the third chip.

20. The phased-array system according to claim 19, wherein the second function layer and the fourth functional layer are configured to dissipate heat.
